(19) United States
(12) Patent Application Publication
(10) Pub. No.: US 2001/0019102 A1
(43) Pub. Date: Sep. 6, 2001

(54) Light reception circuit capable of receiving large level optical signal

(76) Inventor: Tadayuki Chikuma, Tokyo (JP)

Correspondence Address: MCGINN & GIBB, PLLC, 8321 OLD COURTHOUSE ROAD, SUITE 200, VIENNA, VA, 22182-3817, US

(21) Appl. No.: 09/788,686

(22) Filed: Feb. 21, 2001

(30) Foreign Application Priority Data
Feb. 22, 2000 (JP) 043848/2000

(51) Int. Cl. H01J 40/14

(52) U.S. Cl. 250/214 R

(57) ABSTRACT

A pin photo-diode 13 is used as a light reception device. When an input revel detection circuit 14 detects that an electrical signal outputted from pin photo-diode 13 exceeds a predetermined level, a transmittivity of an EA device 11 is dropped through an EA control circuit 12, and an externally supplied optical input signal is inputted through the EA device 11 to the pin photo-diode 13. Accordingly, a level of an optical signal to be inputted to the pin photodiode 13 can be always reduced to the predetermined level or less without any mount of an input protection circuit and without any usage of two EA devices.

### BACKGROUND OF THE INVENTION

1. Field of the Invention

The present invention relates to a light reception circuit. More particularly, the present invention relates to a technique for receiving an input light in a light transmission by a trunk transmission system used in a high frequency region.

2. Description of the Related Art

There are various kinds of light transmissions by the trunk transmission system used in a high frequency region, such as an intra-station transmission, a station-to-station transmission, a linear relay transmission using an optical amplifier and a long distance transmission. Thus, when an optical signal is transmitted from a light transmission circuit to a light reception circuit, a level difference equal to or greater than 1000 times, such as about 0 dBm (decibels above 1 milliwatt) to about −30 dBm, is induced because of an optical output level of the light transmission circuit, a loss in an optical fiber serving as a transmission medium, an output level of an optical amplifier through a linear relay and the like. Hence, the light reception circuit requires a dynamic range wider than that of a conventional light reception circuit.

To respond this requirement, a light reception circuit has been conventionally proposed for equipping a light attenuator to a former stage of the light reception circuit and adjusting a maximum reception input level to thereby enlarge a dynamic range. However, this light reception has a mechanism in which the light attenuator mechanically changes a light transmittivity. Thus, this results in a problem of a larger size.

In order to solve this problem, Japanese Laid Open Patent Application (JP-A-Heisei, 6-97888) discloses “Light Level Adjusting Circuit”. This light level adjusting circuit is provided with a first electrical field absorption type modulator (EA) 2 and a second electrical field absorption type modulator (EA) 4, as shown in FIG. 1. The thirst electrical field absorption type modulator 2 attenuates an optical input signal 1 at a predetermined rate, and sends as an optical signal 3 to the second electrical field absorption type modulator 4. A light reception sensibility of the second electrical field absorption type modulator 4 is adjusted by adjusting an externally supplied application voltage. A control amplifier 8 adjusts an application voltage of the first electrical field absorption type modulator 2 until a current level of an optical output signal 6 outputted from the second electrical field absorption type modulator 4 coincides with a level corresponding to a standard value. Accordingly, the current level of the optical output signal 6 is held at a predetermined level.

In recent years, a power supply voltage sent to the light reception circuit is reduced in accordance with a requirement of a smaller size and a lower consumptive power of the light reception circuit. In this case, an optical preamplifier and an amplifier having a sufficiently low noise factor (NF) can treat a micro optical signal. However, it is difficult to attain the light reception circuit receiving a light larger than 0 dBm without a circuit for protecting a large input, at a power supply voltage equal to or less than several volts. If it is attempt to use the light reception circuit in a high frequency region, it is not possible to ignore an increase of an input capacitance when the input protection circuit is mounted. Thus, it is actually difficult to attain the light reception circuit of the smaller size and the lower consumptive power to be used in the high frequency region.

The light reception circuit disclosed in Japanese Laid Open Patent Application (JP-A-Heisei, 6-97888) uses the first electrical field absorption type modulator 2 as a variable optical attenuator and uses the second electrical field absorption type modulator 4 as a light receiver. Thus, the two electrical field absorption type modulators are required, which results in a problem of preventing a smaller size and a cheaper cost.

Japanese Laid Open Patent Application (JP-A-Heisei, 8-139700) discloses “Light Receiver, Light Transmitter And Light Separation Method”. The light receiver is provided with an optical waveguide through which a signal light pulse string of a time series is transmitted, a plurality of optical gates which are inserted and arranged at predetermined positions of the optical waveguide and can switch between a transmission mode and a light reception mode on the basis of a presence or absence of a trigger light pulse, a mode switching portion for switching each optical gate from the transmission mode to the light reception mode by sending the trigger light pulse to each optical gate so that each of the plurality of optical gates can receive a predetermined slot included in the signal light pulse string, and a read circuit for reading out as a parallel electric signal each slot received by each of the plurality of optical gates. Thus, it is possible to attain an optical de-multiplexing that is small, light, stable, little in change wave dependency and high in efficiency, as compared with a conventional optical de-multiplexer of optical TDM.

Japanese Laid Open Patent Application (JP-A-Heisei, 9-307506) discloses “Light Receiver”. This light receiver is provided with an optical amplifier for amplifying an optical signal from an optical transmission path, a first photo-electric converter for photo-electrically converting an output of this optical amplifier, and an identifier for identifying a transmission signal from the output of the first photo-electric converter. An electrical field absorption type modulator for increasing a transmittivity when an input optical signal is high and decreasing the transmittivity when the input i signal is low is inserted between the optical amplifier and the first photo-electric converter. So, in the electrical field absorption type modulator, the feature that the transmittivity is changed on the basis of an input light strength is used to improve an extinction ratio of an input signal light and simultaneously suppress an optical noise at a time of space and extremely improve a light reception sensibility. Thus, it is possible to improve the light reception sensibility and contribute to the attainment of non-relay transmission.

Moreover, Japanese Laid Open Patent Application (JP-A-Heisei, 9-331308) discloses “Light Transmitter/Receiver”. This light receiver carries out a two-way communication in a first wavelength band, and carries out a one-way communication in a second wavelength band longer than the first wavelength band. At a time of a transmission in the first wavelength band, a non-modulation light emitted in a light emission device is modulated by an electrical field absorption type light device connected to a modulator, and outputted as a transmission light signal. At a time of a reception, the electrical field absorption type light device converts a reception light signal into an electrical signal, and first reception information is obtained from a first reception circuit. At a time of a reception in the second wavelength band, a reception light signal passed through an integrated light device without any attenuation is inputted to a light reception device through a wavelength selection filter serving as a dielectric multi-layer film filter, and converted into an electrical signal. Then, second reception information is obtained from a second reception circuit. Thus, it is possible to attain the apparatus having a small number of parts without any deterioration of a reception sensibility caused by a leakage of an optical signal or a loss or the like, and use integrated devices to miniaturize the apparatus and make the property thereof higher.

### SUMMARY OF THE INVENTION

Therefore, an object of the present invention is to provide a light reception circuit that can attain an input protection and can be used in a high frequency region.

Another object of the present invention is to provide a light reception circuit having a smaller size and a cheaper cost.

In the present invention, when an output signal of a light reception device exceeds a preset level, a transmittivity of an optical signal level variable device is dropped to thereby reduce a level of an optical signal to be inputted to the light reception device. Thus, the level of the optical signal to be inputted to the light reception device can be always held at the predetermined level or less.

When a pin photo-diode or an avalanche photodiode (APD) is used as the light reception device, it is possible to attain a configuration that is cheaper and smaller than those of a case in which an EA device is used as the light reception device.

### BRIEF DESCRIPTION OF THE DRAWINGS

FIG. 1 is a block diagram showing an example of a conventional light reception circuit;

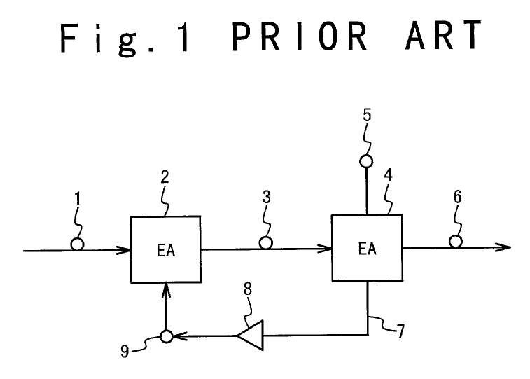

FIG. 2 is a circuit diagram showing a configuration of a light reception circuit according to an embodiment of the present invention; and

FIGS. 3A and 3B are timing charts describing an operation of the light reception circuit according to the embodiment of the present invention.

### DESCRIPTION OF THE PREFERRED EMBODIMENT

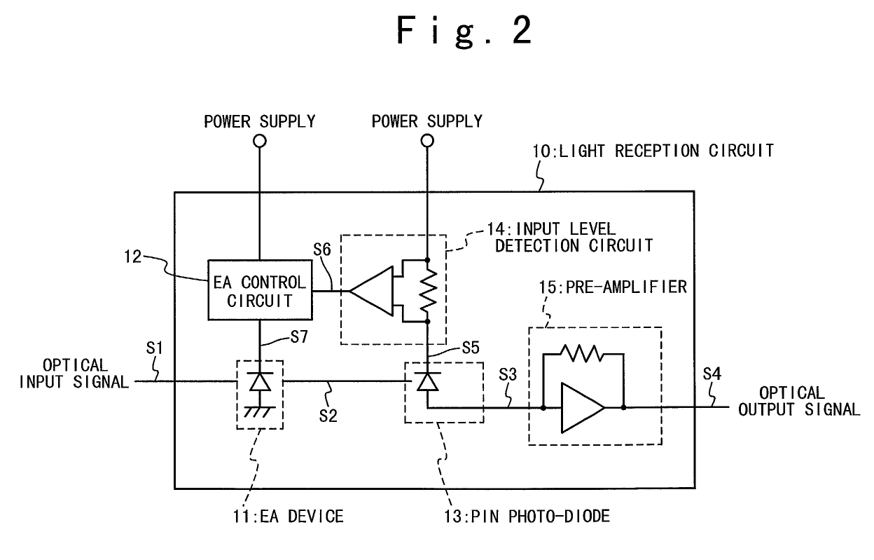

An embodiment of the present invention will be described below with reference to the attached drawings. FIG. 2 is a circuit diagram showing a configuration of a light reception circuit 10 according to an embodiment of the present invention.

This light reception circuit 10 is composed of an electric field absorption-type device (hereafter refereed to as EA device) 11, an EA control circuit 12, a pin photo-diode 13, an input level detection circuit 14 and a pre-amplifier 15.

The EA device 11 is an optical signal level variable device having a characteristic in which a transmittivity of a light is changed on the basis of a voltage applied from an external portion. An optical input signal S1 inputted from the external portion is passed through the EA device 11, at a transmittivity corresponding to a voltage of a control signal S7 applied from the EA control circuit 12, and is sent to the pin photo-diode 13.

The pin photo-diode 13 is the light reception device. This pin photo-diode 13 has a known structure in which an I-layer of a low concentration is mounted between PN-conjunctions of a semiconductor. The portion between the EA device 11 and the pin photodiode 13 may be connected in either of an optical fiber, a waveguide and a collectively grown element formed unitary. An optical signal S2 from the EA device passes this portion and is sent to the pin photo-diode.

The pre-amplifier 15 preliminarily amplifies a signal S3 from the pin photo-diode 13, and outputs as an optical output signal S4 to the external portion.

The EA control circuit 12 generates the control signal S7 having a voltage corresponding to a detection signal S6 from the input level detection circuit 14, and sends to the EA device 11.

The input level detection circuit 14 detects whether or not an optical level to be inputted to the pin photo-diode 13 exceeds a predetermined level based on a control signal S5. The detected result is sent as the detection signal S6 to the EA control circuit 12.

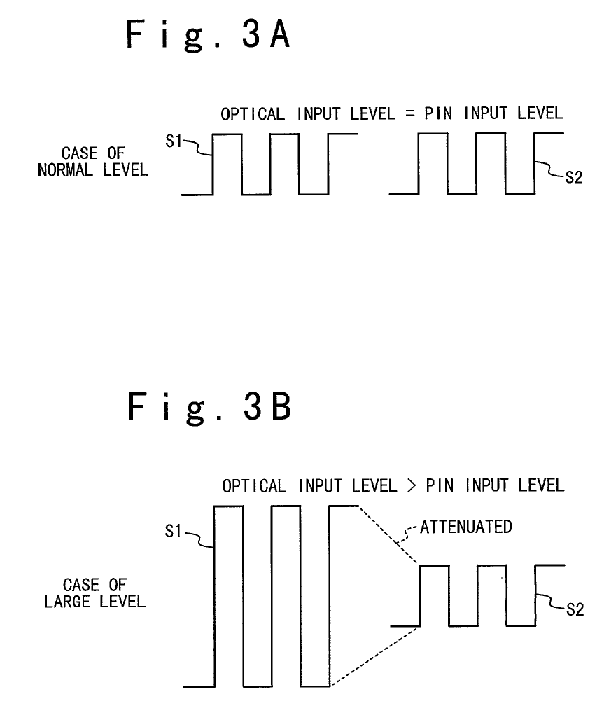

Now, an operation of the light reception circuit according to the embodiment of the present invention having the above configuration will be described with reference to a timing chart shown in FIG. 3.

An optical input signal Si in a high frequency region is inputted to the EA device 11. The inputted optical input signal S1 is usually passed in its original level through the EA device 11, and supplied to the pin photo-diode 13. The pin photo-diode 13 converts a received optical signal S2 into an electric signal S3 and sends the signal S3 as an optical current to the pre-amplifier 15. Then, the pre-amplifier 15 converts the inputted optical current into a voltage and outputs as an optical output signal S4.

Also, the optical current generated by the pin photo-diode 13 is sent to the input level detection circuit 14 as a control signal S5. This input level detection circuit 14 detects whether or not a level of the control signal S5, i.e. a level of the optical current exceeds a preset optical current level. The level of the optical current corresponds to an optical level of the optical input signal S1. Therefore, the input level detection circuit 14 carries out an operation equivalent to an operation for detecting whether or not the optical level of the optical input signal S1 exceeds a preset optical level.

If the optical current level is equal to or less than the preset level (normal level), as shown in FIG. 3A, an optical input signal S1 is transmitted in its original level through the EA device 11, and supplied as an optical signal S2 to the pin photo-diode 13. On the contrary, if the optical current level exceeds the preset level (large level), the optical level detection circuit 14 sends a detection signal S6 indicative of above fact to the EA control circuit 12. In response to this detection signal S6, the EA control circuit 12 applies a control signal S7, which is a voltage signal, to a predetermined terminal of the EA device 11. Accordingly, the transmittivity of the EA device 11 is dropped.

Thus, if the optical level of the optical input signal S1 exceeds the preset optical level as shown in FIG. 3B, the optical level of the optical signal S2 to be inputted to the pin photo-diode 13 is reduced by the control of dropping the transmittivity of the EA device 11, as shown by a symbol S2 of FIG. 3B. As a result, the optical signal S2 to be inputted to the pin photo-diode 13 is controlled so as not to exceed the preset optical level.

Accordingly, even when an optical input signal S1 having a high level is received, the optical signal S2 that does not exceed the preset optical level is always supplied to the pin photo-diode 13. Thus, it is possible to reduce an overload on the pin photodiode 13. Also, even if a power supply voltage of the pre-amplifier 15 is a low voltage, it is possible to design the light reception circuit 10 that does not contain an input protection circuit. Moreover, a minute optical input signal S1 is transmitted in its original state through the EA device 11, and supplied to the pin photo-diode 13. Hence, there is no deterioration in the optical input signal S1.

It should be noted that the above-mentioned embodiment uses the pin photo-diode 13 cheaper than the EA device (for example, about ½ in cost), as the light reception device. However, it is allowable to use another photo-diode, for example, an avalanche photo-diode (APD), which is cheaper than the EA device.

As mentioned above, according to the present invention, when the output signal of the light reception device exceeds the preset level, the transmittivity of the optical signal level variable device is dropped to thereby reduce the level of the optical signal to be inputted to the light reception device. Thus, the level of the optical signal to be inputted to the light reception device is always set at a level equal to or less than the predetermined level. So, even when the optical level having a high level is received, it is possible to reduce the overload on the light reception device. Also, at the time of the input of the minute optical signal, it is transmitted in its original state through the optical signal level variable device, and supplied to the light reception device. Thus, there is no deterioration in the input optical signal. Hence, it is possible to improve a noise factor (NF) of a circuit, as compared with the case when the protection against the input of the optical signal having the high level is carried out by an electrical circuit.

Also, according to the present invention, the pin photo-diode or the avalanche photo-diode (APD) is used as the light reception device. Thus, it is possible to design the configuration that is cheaper and smaller than that of the case when the EA device is used as the light reception device. Hence, it is possible to reduce the cost and miniaturize the light reception circuit as a whole.

Moreover, according to the present invention, even when the optical signal having the high level is receive, it can be designed such that the light reception device does not suffer from the overload. Thus, even if the power supply voltage of the pre-amplifier mounted on the output side of the light reception device is the low voltage, it is possible to design the light reception circuit without any input protection circuit.

What is claimed is:

1. A light reception circuit comprising:
an optical signal level variable device which receives an optical input signal externally supplied;
a light reception device which converts an optical signal supplied from said optical signal level variable device into an electrical signal;
a detection circuit which detects whether or not the electrical signal outputted from said light reception device exceeds a predetermined level; and
a control circuit which changes a transmittivity of said optical signal level variable device based on the detection result of said detection circuit.

2. The light reception circuit according to claim 1, wherein said control circuit changes said transmittivity such that said transmittivity is dropped when said detection circuit detects that said electrical signal outputted from said light reception device exceeds said predetermined level, and said transmittivity is not dropped when said detection circuit detects that said output signal outputted from said light reception device is equal to or less than said predetermined level.

3. The light reception circuit according to claim 2, further comprising:
a pre-amplifier which operates at a low power supply voltage to preliminarily amplify a signal outputted from said light reception device under.

4. The light reception circuit according to claim 3, wherein said optical signal level variable device and said light reception device are connected to each other through either one of an optical fiber and a waveguide.

5. The light reception circuit according to claim 4, wherein said optical signal level variable device is an electric field absorption-type device.

6. The light reception circuit according to claim 5, wherein said light reception device is a pin photodiode.

7. The light reception circuit according to claim 5, wherein said light reception device is an avalanche photo-diode.

8. The light reception circuit according to claim 3, wherein said optical signal level variable device and said light reception device are made unitary.

9. The light reception circuit according to claim 8, wherein said optical signal level variable device is an electric field absorption-type device.

10. The light reception circuit according to claim 9, wherein said light reception device is a pin photodiode.

11. The light reception circuit according to claim 9, wherein said light reception device is an avalanche photo-diode.
